(19) United States
(12) Patent Application Publication
(10) Pub. No.: US 2005/0108016 A1
(43) Pub. Date: May 19, 2005

(54) Alphanumeric character card game forming sentences or phrases known as instant messages and method of play

(76) Inventor: James Halvis, Severna Park, MD (US)

Correspondence Address: James Halvis, 549 Devonshire Court, Severna Park, MD, 21146, US

(21) Appl. No.: 10/985,416

(22) Filed: Nov. 10, 2004

Related U.S. Application Data
(60) Provisional application No. 60/519,380, filed on Nov. 13, 2003.

(51) Int. Cl. G06F 17/27

(52) U.S. Cl. 704/272

(57) ABSTRACT

An alphanumeric character card game forming sentences or phrases known as instant messages whereby letter and number cards are combined as traditional English words, abbreviations, numbers as words, acronyms, or phonetic or representative combinations corresponding to a word. Phonetic and representative combinations corresponding to a word are known as instant message words. Points are determined by adding the number of traditional words, abbreviations, numbers used as words, acronyms, instant message words and total alphanumeric character cards used in the sentence or phrase. A bonus point is added to a player's point total for each instant message word used in the sentence or phrase. The first player to reach a predetermined point total is the winner. Game emphasis is placed on using instant message words, which provide numerous options for forming sentences or phrases with a minimum number of playing cards. Only instant message words listed in the game dictionary are permitted.

### CROSS REFERENCE TO RELATED APPLICATIONS

This application is based on provisional application Ser. No. 60/519,380, filed on Nov. 13, 2003.

### STATEMENT REGARDING FEDERALLY SPONSORED RESEARCH OR DEVELOPMENT

Not Applicable

### DESCRIPTION OF ATTACHED APPENDIX

Not Applicable

### REFERENCES

U.S. Patent Documents

U.S. Patent Documents

| | | | |
|---|---|---|---|
| 4185830 | January 1980 | James | 273/157R |
| 4333656 | June 1982 | Sommer | 273/299 |
| 4690409 | September 1987 | Scalia | 273/299 |
| 4826437 | May 1989 | Havard | 434/167 |
| 5417432 | May 1995 | Dwyer | 273/299 |
| 6234486 | May 2001 | Wallice | 273/299 |
| 6454262 | September 2002 | Wilt et al. | 273/243 |

### BACKGROUND OF THE INVENTION

The present invention relates generally to the field of word games and method of play and more specifically to an alphanumeric character card game forming sentences or phrases known as instant messages using phonetic or representative abbreviations found in a game dictionary.

The prior art includes letter and word games found in referenced U.S. patents. These prior art games typically form or decipher words, sentences, phrases, acronyms, abbreviations or phonetic or representative combinations using alphanumeric characters. See for example U.S. Pat. No. 4,690,409, which arranges letters to form abbreviations, acronyms and initials. However, none of these prior art game implementations include a game dictionary listing word abbreviations of phonetic and representative alphanumeric combinations also known as instant message words, which may be used by the game player to form a sentence or phrase.

Furthermore, handheld electronic communications devices such as cell phones, personal digital assistants and pagers have limited display and manual input capabilities. Thus, because of these practical display and input limitations, electronic communications users rely on combinations of proper words, numbers, abbreviations, acronyms, and phonetic or representative alphanumeric character combinations to communicate sentences and phrases with minimum effort. These rapid electronic communications are known as instant messaging or text messaging. The phonetic or representative alphanumeric combinations are not standardized and thus forming and deciphering these instant messages results in a creative and satisfying activity.

### BRIEF SUMMARY OF THE INVENTION

The object of this invention is a word game and method of play in which alphanumeric character cards are drawn from a card stack or card display area and combined to form traditional English words, abbreviations, numbers, acronyms or phonetic or representative combinations. The character card combinations are used to form sentences or phrases. The emphasis of the game is in the use of phonetic and representative card combinations.

Furthermore, points are awarded after a sentence or phrase is formed and presented by adding the number of alphanumeric cards and number of character card combinations including traditional English words, abbreviations, acronyms and phonetic or representative combinations. A bonus point is also awarded to the player presenting the sentence or phrase for each phonetic or representative combination, also known as an instant message word. Instant message words, which are permissible, are listed in a game dictionary, which is provided to each player or team.

A die is used to determine order of play and initial number of cards drawn by each player. The first player to reach a predetermined point total is the winner. Play is accelerated by use of wild cards, which may be substituted for any letter or number card. The emphasis of the game is the use of abbreviations, acronyms, numbers and phonetic or representative combinations, which provide numerous options for forming sentences or phrases with a minimum quantity of alphanumeric character cards.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 illustrates the scoring pad used during game play.

FIG. 2 illustrates a sample page from the game instant message word dictionary.

FIG. 3 illustrates a sample game alphanumeric playing card.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

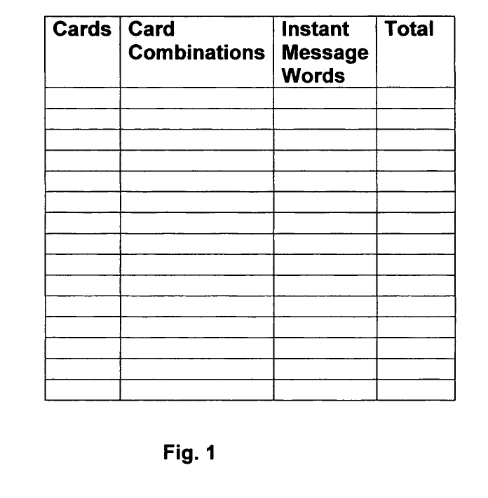

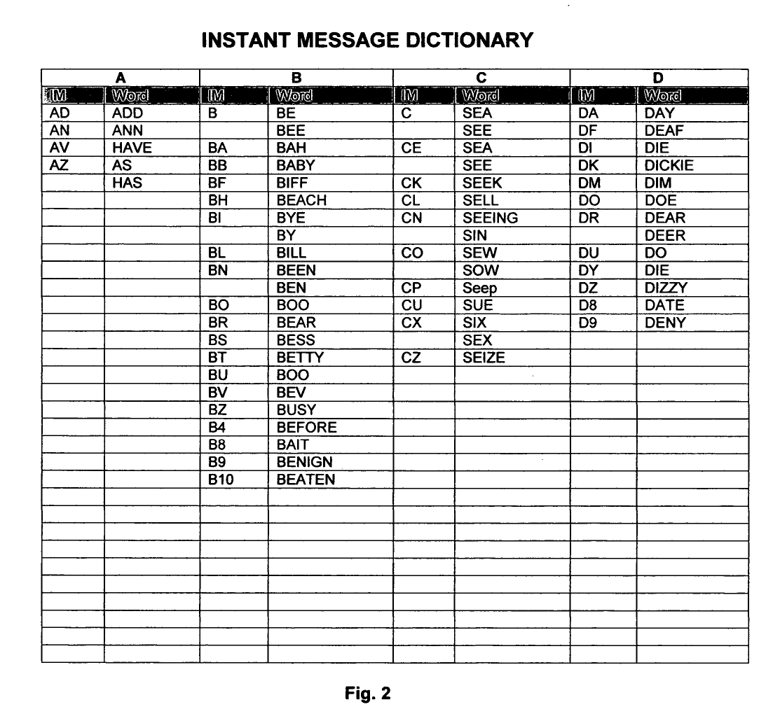

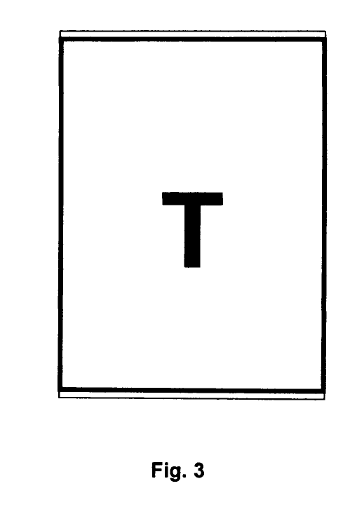

Two to four players or teams may participate in game play. Game equipment includes a die, scoring pads illustrated in FIG. 1, pencils, instant message word dictionaries, a sample of which is illustrated in FIG. 2, which contain phonetic and representative letter and/or number combinations, and 100 playing cards, a sample of which is illustrated in FIG. 3 and are comprised of 97 alphanumeric characters cards and 3 wild cards arranged in a stack with the character face down. Each alphanumeric character card is imprinted on one side with a single alphabetic letter, A through Z or a number 1 through 10. The quantity of each type of alphanumeric character card is selected to facilitate the formation of instant message words found in the game dictionary. The game starts with each player throwing the die and drawing cards from the stack equal to the die point plus an additional 5 cards. Order of play is from highest die point to lowest. In case of point ties, the die is subsequently rolled by the players with equal die point count to determine the order of the tied position, but additional cards are not taken. 20 cards from the stack are then turned character side up and placed in a central display location. In turn, players may present a sentence or phrase for points or pass play.

A sentence or phrase is formed with a minimum of three character card combinations by combining alphanumeric character cards into traditional English words, abbreviations, acronyms, numbers as words or phonetic or representative combinations also known as instant message words. Only one sentence or phrase may be presented during each player turn. After presenting a sentence or phrase, cards are returned to bottom of card stack. If the player does not present a sentence or phrase, the player turns over the top card from the card stack, places the card with the 20 cards already located in the central display location, and draws one card from any of the 21 cards displayed in the central location with character side up, and then passes play to the next player.

Points are scored in the following manner. One point is awarded for each character card used in the sentence or phrase; and one point is awarded for each character card combination consisting of a traditional English word, abbreviation, acronym, number used as a word, or phonetic or representative combination used in the sentence or phrase; and one bonus point is awarded for each phonetic or representative combination also known as an instant message word used in the sentence or phrase. The first player to reach 100 points is the winner. For extended play, the point total to win may be increased to greater than 100 points. Emphasis of the game is using abbreviations, acronyms, numbers, and phonetic and representative combinations also known as instant message words, because fewer cards are required to form sentences or phrases and thus scoring points is accelerated.

In the preferred embodiment, a dictionary of phonetic and representative letter and/or number combinations also known as instant message words is provided to each player or team to assist with forming combinations. Players may add their own phonetic and representative combinations to each dictionary. Plurals, possessives or contractions may be formed by adding S or Z to appropriate instant message card combinations. To add interest and speed play, three wild cards are included in the 100-card set. Players may substitute a wild card as any one alphanumeric character card.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A method of playing a card game in which players draw or select alphanumeric character cards from a set of playing cards and combine the cards as traditional English words, abbreviations, acronyms, numbers as words, or phonetic or representative combinations also known as instant message words, which are listed in a game dictionary of permissible instant message card combinations; and use the character card combinations to form sentences or phrases with a minimum of three character card combinations.

2. A method of scoring game defined in claim 1, whereby one point is awarded for each alphanumeric character card used in the sentence or phrase; and one point is awarded for each traditional English word, abbreviation, acronym, number used as a word, or phonetic or representative letter and/or number combination, also known as an instant message word used in the sentence or phrase; and one bonus point is awarded for each phonetic or representative letter and/or number combination, also known as an instant message word used in the sentence or phrase.

3. A set of playing cards defined in claim 1, whereby the quantities of individual alphanumeric characters is selected to facilitate rapid formation of phonetic and representative combinations also known as instant message words and found in the game dictionary of instant message word character card combinations.

4. A set of playing cards defined in claim 1, whereby wild cards are included and may be substituted for any alphanumeric character card.

5. A method of play defined in claim 1, by which plurals, possessives or contractions are formed by adding S or Z to appropriate instant message words found in the game dictionary of instant message card combinations.

6. An embodiment of game defined in claim 1, whereby alphanumeric character cards are combined as ethnic, slang or non-English words, abbreviations, acronyms, numbers used as words or phonetic or representative letter and/or number combinations also known as instant message words to form sentences or phrases.

7. A game dictionary listing phonetic and representative letter and/or number combinations, which are abbreviations of conventional English words and may be used as instant message word combinations in forming sentences or phrases.
